(19) United States
(12) Patent Application Publication
(10) Pub. No.: US 2013/0103776 A1
(43) Pub. Date: Apr. 25, 2013

(54) NETWORK SYSTEMS AND METHODS

(71) Applicants: Daniel Milton Alley, Earlysville, VA (US); Shawn Michael Hinchy, Roanoke, VA (US)

(72) Inventors: Daniel Milton Alley, Earlysville, VA (US); Shawn Michael Hinchy, Roanoke, VA (US)

(73) Assignee: General Electric Company, Schenectady, NY (US)

(21) Appl. No.: 13/280,187

(22) Filed: Oct. 24, 2011

(51) Int. Cl. G06F 15/173; G06F 15/16

(52) U.S. Cl. 709/208; 709/223

(57) ABSTRACT

System and methods are provided. In one embodiment, a system includes a network protocol handler circuitry configured to communicate by using a network protocol, and a signal interface and timing circuitry communicatively coupled to the network protocol handler circuitry. The system further includes a diagnostic circuitry configured to provide network condition information, and a communications interface communicatively coupled to the signal interface and timing circuitry. The communications interface includes a first line receiver circuitry communicatively coupled to a network connector and configured to receive a first voltage and a first current associated with the network protocol. The communications interface further includes a push-pull driver circuitry configured to produce a second voltage and a second current transmitted through the network connector. The diagnostic circuitry is configured to use at least one of the first voltage, the first current, or a network state information to provide the network condition information.

### BACKGROUND OF THE INVENTION

The subject matter disclosed herein relates to network systems, and more specifically, to the status of network systems.

Certain systems, such as network systems, enable the use of various devices communicatively coupled through the network. For example, a local area network (LAN), such as an Attached Resource Computer Network (ARCNET), may communicatively couple devices in various topologies, including star topologies and bus topologies. The devices may include industrial devices such as controllers and motor drives suitable for industrial applications. It would be beneficial to provide for a status of the network and of its interconnected devices.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a network protocol handler circuitry configured to communicate by using a network communications protocol, and a signal interface and timing circuitry communicatively coupled to the network protocol handler circuitry. The system further includes a diagnostic circuitry configured to provide network condition information, and a communications interface communicatively coupled to the signal interface and timing circuitry. The communications interface includes a first line receiver circuitry communicatively coupled to a network connector and configured to receive a first voltage and a first current associated with the network communications protocol. The communications interface further includes a push-pull driver circuitry configured to produce a second voltage and a second current transmitted through the network connector. The diagnostic circuitry is configured to use at least one of the first voltage, the first current, or a network state information to provide the network condition information.

In a second embodiment, a method includes deriving a network state and a network state transition by using a network protocol finite state machine (FSM). The method further includes deriving a network condition based on the network state, the network state transition, or a combination thereof. The method additionally includes providing feedback based on the network condition, wherein the finite state machine includes an Attached Resource Computer Network (ARCNET) version 878.1 or a higher version protocol.

In a third embodiment, a system includes a network card configured to communicate by using a network protocol. The network card includes a network protocol handler circuitry configured to communicate by using the network protocol, and a signal interface and timing circuitry communicatively coupled to the network protocol handler circuitry. The network card further includes a diagnostic circuitry configured to provide network condition information, and a communications interface communicatively coupled to the signal interface and timing circuitry. The communications interface includes a first line receiver circuitry communicatively coupled to a network connector and configured to receive a first voltage and a first current associated with the network protocol. The communications interface further includes a push-pull driver circuitry configured to produce a second voltage and a second current transmitted through the network connector. The diagnostic circuitry is configured to use at least one of the first voltage, the first current, or a network state information to provide the network condition information.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment a star topology of a network system including a control system;

FIG. 2 timing diagram of an embodiment of network signals traversing the network system of FIG. 1;

FIG. 3 is a timing diagram of an embodiment of current levels traversing the network system of FIG. 1;

FIG. 4 is a timing diagram of an embodiment of voltage levels traversing the network system of FIG. 1;

FIG. 5 is a block diagram of an embodiment of a circuitry suitable for providing status information for the network system of FIG. 1; and

FIG. 6 is a state diagram of an embodiment of a network protocol used by the network system of FIG. 1; and

FIG. 7 is a flowchart of an embodiment of a process suitable for deriving status information for the network system of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Certain network systems, such as an ARCNET LAN system, may be used to communicatively couple a plurality of devices. For example, devices or nodes including controllers, motor drives, computers (e.g., personal computers, laptop computers, tablets), may be networked as part of an industrial environment such as an industrial plant. ARCNET in particular, as defined in the American National Standards Institute (ANSI) ARCNET version 878.1 and higher, lends itself well to industrial installations due to its deterministic performance, robustness, and spanning distances enabled between nodes. However, certain networks systems, including ARCNET, may be difficult to monitor and diagnose. For example, the ARCNET network may experience connectivity problems due to faulty nodes, cabling, and the like. Service personnel may then be used to progressively disconnect and connect nodes from the network, looking for a faulty node or cable. Some ARCNET networks may have hundreds of nodes connected throughout an industrial plant. As can be appreciated, connecting and disconnecting network equipment throughout the plant may be substantially disruptive to plant operations, costly, and inefficient. The systems and methods described herein provide for improvements in the monitoring of the network system, including diagnostic monitoring, by providing visual indications of condition status information. In one embodiment, a set of light emitting diode (LED) lights may be used to deliver information relating to the status of a node in the network and/or the overall network status by displaying different lights and/or different colors associated with the status information. In other embodiments, the status information may be provided textually, graphically (e.g., by displaying icons), audibly (e.g., by sounding different tones or alarms), or a combination thereof.

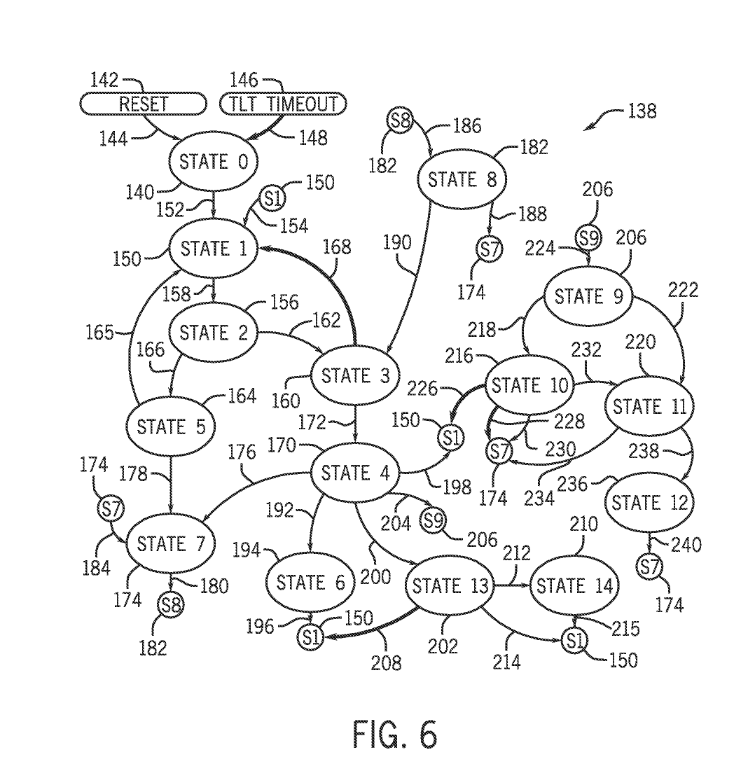

The status information may be derived through monitoring of the network communications, among others. In certain examples, voltage and/or current levels associated with network communications may be used, as described in more detail below. In another example, network communication standards or protocols, such as network states and transitions between states, may be used to derive status information. For example, the network protocol may define a finite state machine (FSM) and related state diagram, such as a state diagram described in more detail with respect to FIG. 6, detailing the states and state transition information. By incorporating the current state of the node (e.g., ARCNET station) in addition to having knowledge of the protocol's state machine, useful network status information may be derived. In one embodiment, a field-programmable gate array (FPGA) may be used to derive status information based on the voltage levels, current levels, and/or current state of the network node. In other embodiments, other hardware suitable for executing logic operations, such as a programmable array logic (PAL), an application specific integrated circuit (ASIC), a complex programmable logic device (CPLD), a custom circuit, or a combination thereof, may be used alternative to or additional to the FPGA. The FPGA may then communicate the status information through the use of the LED lights, text, graphics, and/or sounds. By providing for a more efficient presentation of network status information, the systems and methods disclosed herein may enable a more efficient maintenance, diagnostics, and utilization of network resources.

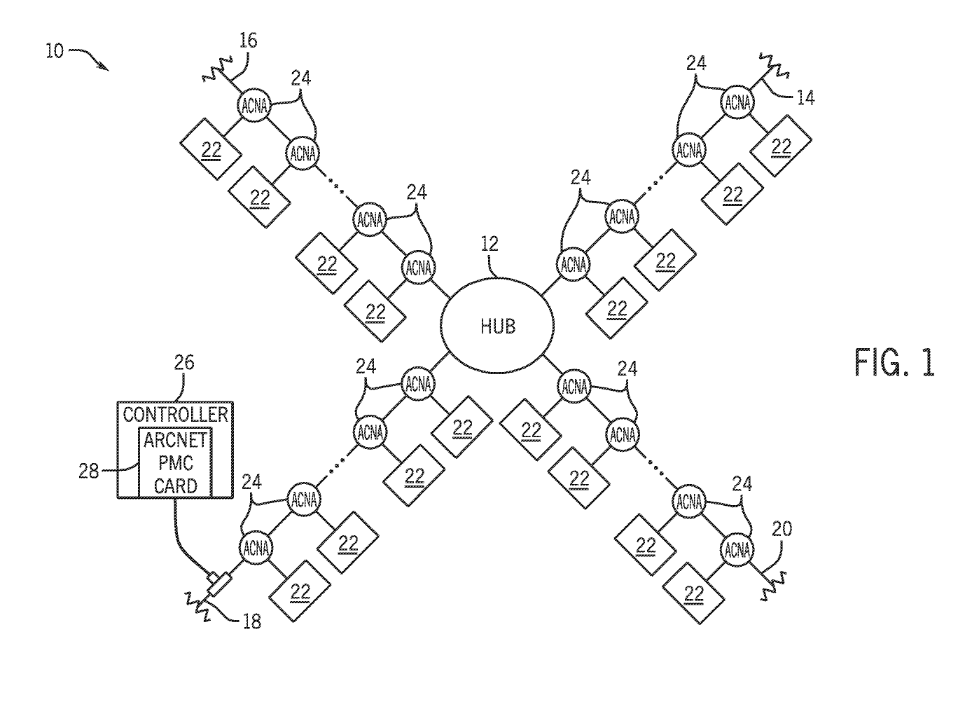

With the foregoing in mind and turning now to FIG. 1, the figure depicts a diagram of an embodiment of a network system 10 having a star topology. In other embodiments, the network system 10 may be arranged in a daisy chain topology, bus topology, ring topology, or a combination thereof. In the depicted embodiment, an ARCNET hub 12 is used to communicatively couple four branches 14, 16, 18, and 20 of the network system 10 to each other by using the ARCNET protocol. Each branch 14, 16, 18, and 20 may include one more devices 22 communicatively coupled to the branches 14, 16, 18, and 20 by using network cards 24 (e.g., ARCNET connect board available from General Electric Co., of Schenectady, N.Y., USA, under the designation DS200ACNA). The devices 22 may include motor drives, actuators, pumps, valves, turbine systems, compressors, generators, air separation units (ASUs), boilers, heat recovery steam generators (HRSGs), gasifiers, gas treatment units, and so on. A controller 26 may also be communicatively coupled into the network system 10 by using, for example, a network card 28. For example, the network card 28 may be a Peripheral Component Interconnect (PCI) Mezzanine Card (PMC) combining the electrical characteristics of a PCI bus with the mechanical dimensions of a Common Mezzanine Card (CMC).

Each of the cards 24 and 28 may be assigned an individual address or identification, such as a medium access control (MAC) address. The networks system 10 may then implement a communications protocol to communicate amongst the nodes in the network (e.g., devices 22 and controller 26). In the depicted example, a token-passing protocol may be used. A node (e.g., one of the devices 22 or the controller 28) may only send a message when the node receives a token, such as an invitation to transmit (ITT) token. Upon receipt of the token, that node becomes a momentary master of the network for a specified amount of time. The node may then transmit a data packet while “holding” the token and pass the token to another node in the network, until all the nodes have had a chance to transmit data. By transmitting only when the node has the token, the time performance of the network system 10 becomes predictable or deterministic. Such predictability enables control systems, including the controller 26, to provide for control events that occur in a timely and predictable fashion.

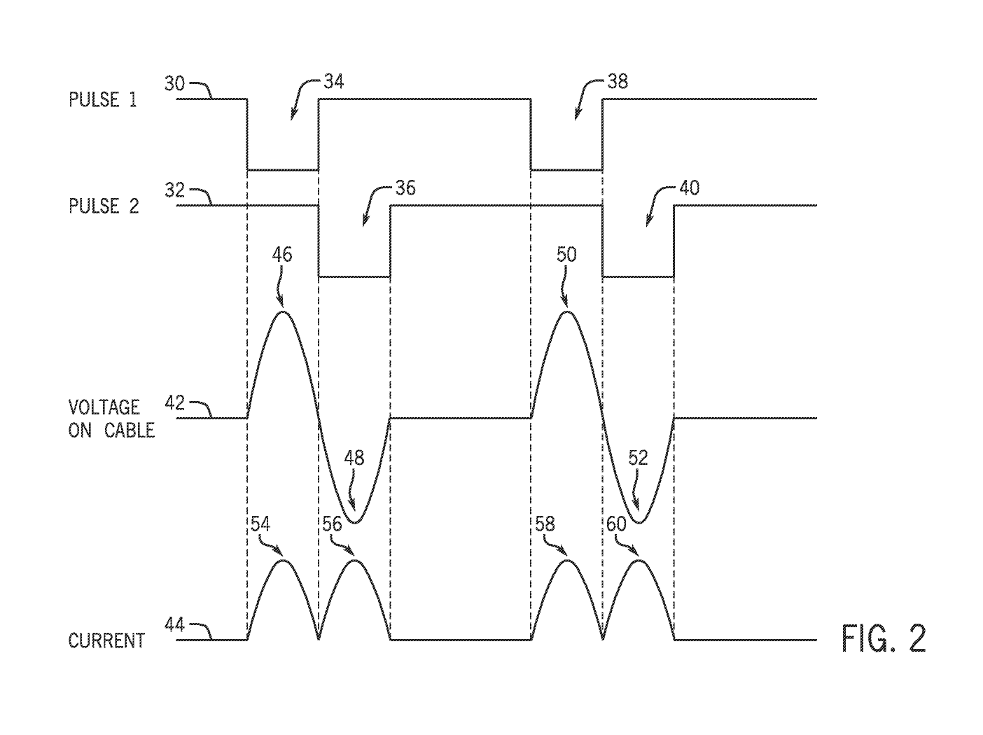

In the depicted embodiment, each branch 14, 16, 18, and 20 may include an electrical conduit, such as a cable, useful for the transmittal of electric signals (e.g., current and voltage). For example, the cable may be a coaxial cable having Bayonet Neill-Concelman (BNC) connectors connecting the branches 14, 16, 18, and 20 to the devices 22 and controller 28. Other type of cables may be used, including but not limited to unshielded twisted pair (UTP) cable and fiber optic cable. The electric signals conducted by the cable may be used by the network system 10 as a medium for transmitting data through the branches 14, 16, 18, and 20. In the presently contemplated ARCNET protocol example, pulsed electric signals may be used, as described in more detail with respect to FIG. 2 below. By analyzing the pulsed electric signals, certain network 10 status or conditions may be derived and displayed visually.

FIG. 2 is a timing diagram illustrating an embodiment of pulsed signals 30 and 32 suitable for transmitting data through the network system 10 shown in FIG. 1. The first signal 30 may be followed by the second signal 32 as a dipulse signal transmission having a default data rate of 2.5 Mbps. Other rates may also be used, such as 2.4 Mbps, 5 Mbps, 10 Mbps, and higher. The depicted pulses 34 and 36 may be logically interpreted as representing a logic or bit “0.” Likewise, the depicted pulses 38 and 40 may be logically represented as a second “0.” By transmitting the depicted signals 30 and 32, a succession of “0” and “1” may be transmitted, representing binary data. Such binary data may be encapsulated in a frame, and transmitted through the network system 10 to the devices 22 and controller 28. Indeed, while only one node holding the token (e.g., ITT) may be transmitting data, for example, data directed at a particular node, all the other nodes in then network system 10 may receive the data transmitted by the node holding the token.

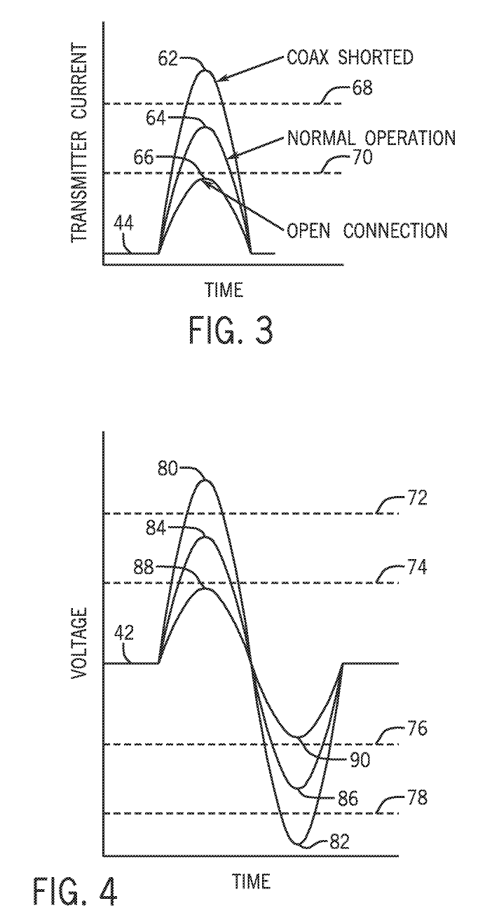

FIG. 2 also depicts a sinusoidal voltage 42 and a dipulse current 44 correlative to the signals 30 and 32. For example, the pulse 34 may result in a positive voltage peak 46 while the pulse 36 may result in a negative voltage peak 48 of the voltage 42. Likewise, the pulse 38 may result in a positive peak voltage 50 while the pulse 40 may result in a negative peak voltage 52. FIG. 2 also depicts a first current peak 54 associated with the pulse 34, followed by a second current peak 56 associated with the pulse 36. Similarly, a current peak 58 associated with the pulse 38, and a current peak 60 associated with the pulse 40 are depicted. In certain embodiments, the voltage 42 and/or the current 44 may be monitored. For example, voltage 42 and current 44 levels may be monitored, and deviations from expected values may be used to derive network 10 conditions, as described in more detail below with respect to FIG. 3

FIG. 3 is a timing diagram of an embodiment a peak of the current 44 having three transmitted current measurements 62, 64, and 66. The diagram also depicts thresholds 68 and 70. As mentioned above, the current 44 may be monitored or measured to derive certain networking conditions. For example, if a current measured value is detected as occurring under the threshold 70, such as the current measure 66, then the node may be experiencing an open connection, thus reducing current 44 levels. During normal operations, a current measurement, such as the current measurement 64, would typically be found between the thresholds 68 and 70. Accordingly, current 44 measurements detected between the thresholds 68 and 70 would be used to derive that the node is operating normally. However, current measurements above the threshold 68, such as the current measurement 62, may be evidence of a short in cabling or other equipment. Accordingly, current 44 levels above the threshold 68 may be used to derive that the node is operating with a short.

By analyzing the current 44, various networking conditions may be found and then communicated to a user or operator. A set of lights, text, or audio notifications may then be used to notify the user of the networking conditions. For example, a green LED may be displayed during normal operations, a yellow LED may be used to display an open connection, and a red LED may be used to display a short condition. It is to be noted that other colors, textual messages, and audible alerts may be provided. It is also to be noted that the thresholds 68 and 70 may be adjustable. That is, the systems and methods described herein may enable adjustment of the thresholds 68 and 70, for example, to provide for calibration in different networking environments.

Voltage 42 measurements may also be used to derive networking conditions, as depicted in the embodiments of FIG. 4. In the depicted embodiments, voltage thresholds 72, 74, 76, and 78 may be used to detect the networking conditions. For example, if the voltage 42 is positive, voltage measurements above the threshold 72, such as a measurement 80, may be used as evidence of an open circuit. Likewise, if the voltage 42 is negative, voltage measurements below the threshold 78, such as a measurement 82, may also be evidence of an open circuit.

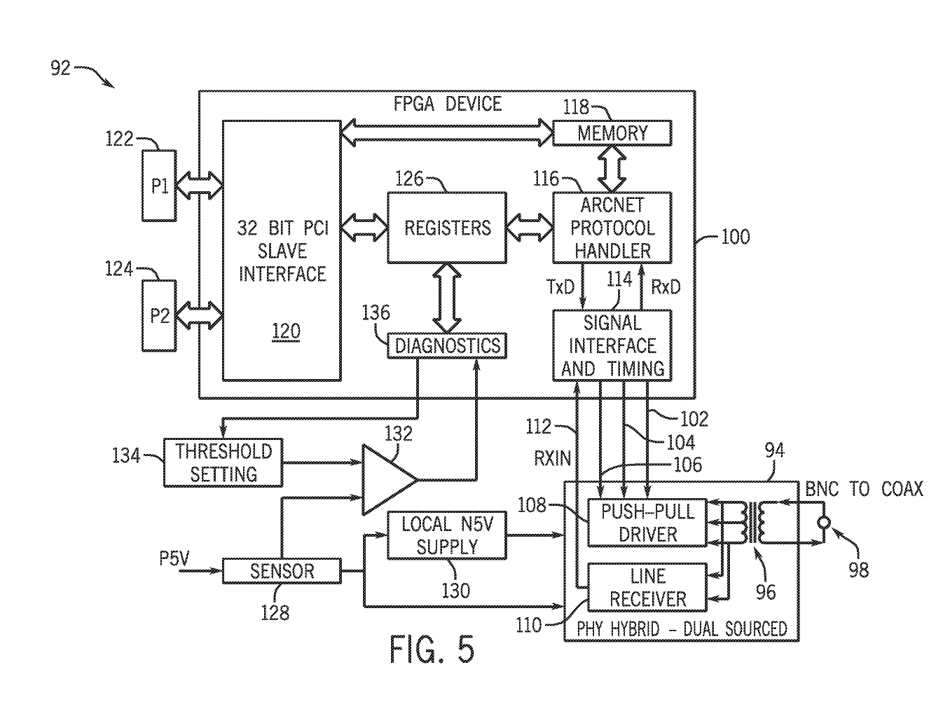

Measurements, such as measurements 84 and/or 86 located between thresholds 72 and 74 and/or between thresholds 76 and 78 may provide for evidence of normal operations. However, other measurements between the thresholds 74 and 76, such as the measurements 88 and 90, may be evidence of a short in the cable or other equipment. By detecting and comparing the voltage 42 against the thresholds 72, 74, 76, and 78, in addition or alternative to using the current 44, useful networking conditions may be derived. The thresholds 72, 74, 76, and 78 may be adjustable, for example, to provide for calibration adjustments. In one embodiment, a circuitry depicted in FIG. 5 may be communicatively coupled to the network system 10 and used to monitor voltage 42 and/or current 44.

FIG. 5 is a block diagram of an embodiment of an electronic circuitry 92 suitable for deriving network 10 condition information. The circuitry 92 may be included, for example, in the network cards 24 and/or 28 depicted in FIG. 1. In the depicted embodiment, the circuitry 92 is communicatively coupled to the network system 10 through a communications interface 94. The communications interface 94 may include a galvanic isolator (e.g., transformer 96) coupled to a BNC connector 98. In one embodiment, the communications interface 94 is a hybrid interface, which may be available commercially. In another embodiment, the communications interface 94 may be provided as including a custom discrete component-based design. A field-programmable gate array (FPGA) device 100 is also depicted, which uses the communications interface 94 to transmit and to receive network 10 data.

As mentioned above with respect to FIG. 2, pulsed signals may be used to drive electric voltage 42 and current 44 through cabling, such as the cabling connected to the BNC connector 98. Indeed, in the depicted embodiment, the FPGA 100 may drive certain signals through pins 102, 104, and 106. For example, pulses 30 and 32 (shown in FIG. 2) and a TXEN signal may be driven through the pins 102, 104, and 106, respectively. The TXEN signal may be used in certain communication embodiments, such as a backplane mode supported by ARCNET systems. The signals driven through the pins 102, 104, and 106 may be converted into voltage 42 and current 44 by a push-pull driver 108. Additionally, a line receiver 110 may convert signals received by the transformer 96 into receiver (RXIN) signals transmitted into the FPGA 100 through a RXIN pin 112. The FPGA 100 may include a signal interface and timing circuitry 114 that may be used to receive the RXIN signals through the pin 112 and drive the pulses 30, 32 and TXEN signal through the pins 102, 104, and 106.

The signal interface and timing 114 may be communicatively connected with a protocol handler, such as an ARCNET protocol handler 116. The ARCNET protocol handler 116 may include logic or executable instructions suitable for communication using the ARCNET protocol version 878.1 and higher. For example, the ARCNET protocol handler 116 may include a finite state machine (FSM) stored in a memory 118, as described in more detail below with respect to FIG. 6, used in communicating by using the ARCNET protocol. The FPGA 100 may also include a PCI slave interface, such as a 32-bit PCI slave interface 120. The PCI interface 120 may be communicatively coupled to a P1 bus connector 122 and a P2 bus connector 124. The P1 and P2 bus connectors 122 and 124 may be used to interface with a 32-bit bus included in the devices 22 or controller 28. The PCI slave interface 120 may also communicate with the memory 118 and with registers 126. The registers 126 may be used as storage for configuration, control, and status information, and are also accessible by the ARCNET protocol handler 116. Accordingly, ARCNET data incoming from the BNC connector 98 may be processed by the FPGA 100, and transmitted to the connectors 122 and 124. Likewise, data incoming from the connectors 122 and 124 may be processed by the FPGA 100, and transmitted to the BNC connector 98 as ARCNET data. In this manner, the circuitry 92 may be used as a communicative interface suitable for implementing the ARCNET protocol. Additionally, the circuitry 92 may be used to derive networking conditions representative of the status of certain components of the network system 10.

In the depicted embodiment, a sensor 128 may sense voltage 42. Additionally or alternatively, the sensor 128 may sense current 44. For example, the sensor 128 may be connected to the communications interface 94 and to a power supply 130 to sense voltage 42 and/or current 44 from the interface 94 and from the power supply 130. The sensor 128 measurements may then be provided to a comparator 132. The comparator 132 may compare the sensor 128 measurements with values submitted by a threshold setting circuitry 134. The values provide by the threshold setting circuitry 134 may define the thresholds 68, 70, 72, 74, 76, and 78 shown in FIGS. 3 and 4. Results measured by the comparator 132 may then be provided to a diagnostic circuitry 136. In one embodiment, the diagnostic circuitry 136 may then derive conditions such as shorts in cabling, open connections, normal operations, and the like, based on the threshold values 68, 70, 72, 74, 76, and 78 provided by the diagnostic circuitry 136, as described above with respect to FIGS. 3 and 4. The derived conditions may then be provided to a user by LEDs, textual messages, graphical displays, and/or audible alerts. In this manner, the circuitry 92 may sense voltage 42 and/or current 44, and provide the user with network-related status information. It is to be noted that certain circuitry, such as the line receiver 110 may be dual sourced, that is, more than one line receiver 110 or dedicated diagnostic circuitry, may be used. In one example, a first line receiver 110 may be used for normal ARCNET communications while a second line receiver 110 may be dedicated for implementing the techniques described herein, such as the use the thresholds 68, 70, 72, 74, 76, and 78 to detect network 10 status. That is, the first line receiver 110 may be dedicated for use solely in ARCNET communications (e.g., transmitting and receiving data), and the second line receiver 110 may be used solely for diagnosing network conditions. In another example, the line receiver 110 may be replaced with a dedicated diagnostic circuitry designed specifically to diagnose network conditions, as described in the previous figures.

Additionally or alternatively, the circuitry 92 may derive network status information by using a state diagram, such the diagram depicted in FIG. 6. More specifically, FIG. 6 illustrates an embodiment of a state diagram 138 included in a FSM of the ARCNET protocol version 878.1 and above. A novel use of the state diagram 138 described herein includes deriving network 10 status information based on state information, state transition information, and/or historical information. For example, if the network system 10 is continuously entering certain states, then this information may be used to derive certain conditions that may be causing such behavior. Indeed, while the traditional use of the diagram 138 includes adhering to the ARCNET protocol version 878.1 or higher during communications, a novel use of the diagram 138 described herein includes monitoring the states and/or state transitions in order to derive network conditions (e.g., network problems, normal network operations).

A state 140 labeled “State 0” is typically used to initialize the network system 10. For example, a reconfiguration (RECON) burst of data may be sent out to nodes in the network system 10 during initialization. State 140 may be entered via a reset 142 and state transition 144 or via a timer lost token (TLT) timeout 146 and state transition 148. If the state 140 is continuously being entered via the TLT timeout 146, then there may be evidence of a problem such as a cable short. For example, the TLT timeout 146 may be occurring multiple times over the course of 1, 2, 5, 10, or 20 seconds. Accordingly, the logic included in the FPGA 100 may detect multiple entries and provide LED, textual, or audio notifications.

It may be useful to describe the remainder states and state transitions, and then provide for a list of some state and state transitions that may be evidence of network 10 issues. After initialization, a state 150 labeled “State 1” may be transitioned into from state 140 via transition 152. The state 150 may then be used to wait for an idle link. Accordingly, the state 150 may be continuously waiting for the idle link through transition 154. On idle link, the state 150 may transition to a state 156 labeled “State 2” through transition 158. The state 156 may then be used to wait for link activity. On link activity, such as a RECON burst or start of a starting delimiter (SD) frame, the state 156 may transition to a state 160 labeled “State 3” through transition 162. If the link is inactive, the state 156 may transition to a state 164 labeled “State 5” through transition 166. State 164 may wait a variable amount of time while checking for RECON activity. If a node having a higher identification has responded to the RECON, then state 164 may transition to state 150 through transition 165.

State 160 may decode a type of frame used during link activity. If the frame is not acceptable, then the state 160 may transition to the state 150 through transition 168. If the frame is acceptable, then the state 160 may transition to a state 170 labeled “State 4” through transition 172. The frame may be one of three types, such as a free buffer enquiry (FBE), invitation to transmit (ITT), or data packet (PAC). State 170 may be used to determine if a packet was meant for the current node or network station. If the packet was meant for the current node and type ITT, but there is nothing to transmit, then the state 170 may enter a state 174 labeled “State 7” through transition 176. State 174 may also be entered from state 164 through transition 178 if there is a timer identifier precedence (TIP) timeout and link is available to this node. The state 174 may send the current token to the next recipient through transition 180 into a state 182 labeled “State 8.” Additionally or alternatively, state 174 may iterate through transition 184. State 182 may then wait for activity after passing a token, and iterate through transition 186. If there is no response in time, the state 182 may increment next station identifier (NID) and resend the token, then transition to state 174 through transition 188. If a response is observed, then the token is accepted by another node or station and state 182 may transition into the state 160 through transition 190.

From state 170, if the frame type is FBE with this node or station address, then a transition 192 may be used to transition to state 194 labeled “State 6.” State 194 may send an acknowledgement (ACK) or a negative acknowledgement (NAK) to link based on current validity, and transition to state 150 through transition 196. The state 170 may also transition to the state 150 through transition 198 if a destination identifier (DID) is not for this station. Also from state 170, if there is a broadcast or if frame type is PAC, then a transition 200 may be used to transition to a state 202 labeled “State 13.” If the frame type is ITT for this node with pending transmit buffer, then transition 204 may be used to transition from the state 170 and into a state 206 labeled “State 9.”

From state 202, the state may complete reception of the packet. If there is an invalid PAC format, then state 202 may transition back to state 150 through transition 208. If the PAC for this node is valid, then state 202 may transition into a state 210 labeled “State 14” through transition 212. If the packet is included in a broadcast, state 202 may transition into state 150 through a transition 214. State 210 may send a reply to the PAC, and transition to state 150 through transition 215.

From state 206, the state may transmit an FBE if there is a single destination for the packet, and transition to a state 216 labeled “State 10” through transition 218. If there are multiple destinations, state 206 may broadcast the packet and transition to a state 220 labeled “State 11” through transition 222. The state 206 may also iterate through transition 224.

From the state 216, the state may wait for reply to the FBE. If the state receives another response having bad framing, transition 226 may be used to transition back to state 150. If there is no response to the FBE, the state may transition to the state 174 through transition 228. Transition 230 may also be used to transition to the state 174 if the NAK is received, for a retry. If ACK is received, then transition 232 may be used to transition to state 220.

From state 220, a PAC may be transmitted. For broadcasts, the state may then transition to state 174 through transition 234. For non-broadcasts, the state may then transition to a state 236 labeled “State 12” through transition 238. State 236 may then wait for a reply to a PAC, and then pass the token, transitioning to state 174 through transition 240. By transition from state to state during network 10 activity, the network system 10 may follow a standard protocol of communication, such as the ATA 878.1 protocol or above. Additionally, the system and methods described herein may use the aforementioned states and state transitions to derive information useful in describing the status of the network system.

In one embodiment, a count of states and state transitions may be used to track how often a state is visited and what transition is used, during a certain time period. For example, counters may be used to count how many times state 146 (TLT timeout state) is present and how many times the transition 148 occurs during a specified time period (approximately between 1 millisecond and 500 milliseconds, approximately between 500 milliseconds and 1 second, approximately between 1 second and 10 seconds). A threshold count may then be used to derive, for example, that too many TLT timeouts are occurring. If the actual count exceeds the threshold count (e.g., more than 1, more than 10, more than 20, more than 100), the LEDs, textual displays, and audio alerts may be engaged to provide feedback that state 140 is being over-transitioned through transition 148.

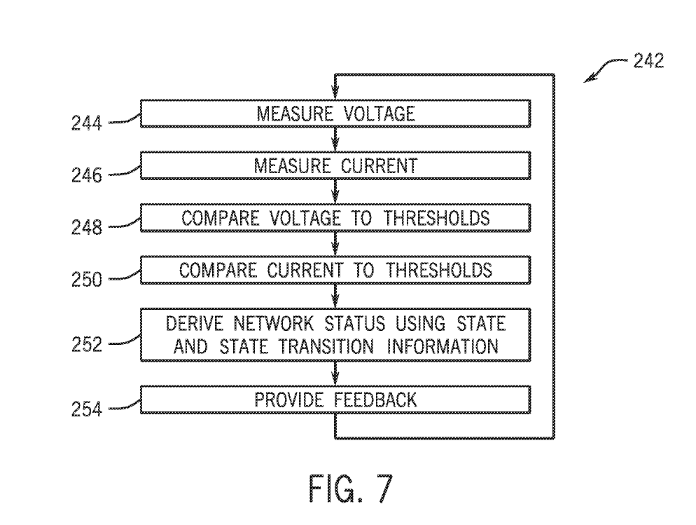

Likewise, similar counters may be used with state 202 and transition 208. If too may invalid PAC formats occur, transition 208 may be over a certain threshold and suitable user feedback (e.g., LEDs, textual displays, audible alerts) may be provided. Similarly, unacceptable frames may result in overuse of transition 168. Framing issues or problems may also be derived through overuse of transition 226. Formatting issues, such as invalid PAC formats, may show through overuse of transition 208. Similarly, unresponsiveness, such as unresponsiveness to FBE may be derived through transition 228. The counter may also combine transitions. That is, two or more transition counters may be summed, and if the sum is over a desired threshold, then user feedback may be provided. Indeed, all of the states and transitions shown in FIG. 6, or a combination thereof, may be similarly used to derive or identify network issues or network status, with user feedback provided based on the derivation. Additionally, or alternatively, the voltage 42 and current 44 thresholds may be used, as described in more detail below with respect to FIG. 7.

FIG. 7 is a flowchart of an embodiment of a process 242 suitable for using voltage 42 measurements, current 44 measurements, and/or states and state transitions in the derivation of a status of the network system 10. In the depicted embodiment, the process 242 may measure the voltage 42 (block 244). As mentioned above with respect to FIG. 5, a voltage and/or current sensor 128 may be provided, suitable for measuring voltage 42 associated with network system 10 communications. Likewise, the process 242 may measure current 44 through the use of the sensor 128 (block 246). In one embodiment, the process 242 may then compare the measured voltage (block 248) using one or more thresholds. For example, the thresholds 68 and 70 may be used, as described above with respect to FIG. 3, to derive certain network 10 conditions.

Similarly, the measured current 44 may be compared (block 250), for example, by using thresholds 72, 74, 76, and 78, to derive network 10 conditions as described above with respect to FIG. 4. Additionally or alternatively, the process 242 may derive network 10 status using state and state transitions information (block 252). In one example, the states and state transitions described above with respect to diagram 138 may be used to determine the network 10 status. Feedback, such as driving LEDs, displaying text, and/or sounding audible alerts, may be provided (block 254). The process 242 may then iterate back to block 244. By using the systems and methods described herein to derive network 10 status, the network 10 may be more efficiently maintained, diagnosed, and operated. Indeed, the systems and methods described herein may optimize the diagnosis of network 10 problems and eliminate the need to disconnect and reconnect devices as a method to diagnose network 10 issues.

Technical effects of the disclosed embodiments of the invention include deriving networking conditions based on the usage of voltage and or current thresholds. For example, measured voltages and currents may be compared against the thresholds, and network status information may be derived based on the comparison. Further technical effects include the usage of state and state transition information alternative or additional to the voltage and current thresholds as a technique for derivation of network conditions. State and state transitions occurring during network communications may provide for evidence of problems. For example, state transitions occurring more frequently (e.g., more than once, more than 10 times, more than 100 times) over a certain time period may be used to derive network conditions. Network condition information may then be presented by using LEDs, text, and/or audible tones.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a network protocol handler circuitry configured to communicate by using a network communications protocol;
a signal interface and timing circuitry communicatively coupled to the network protocol handler circuitry;
a diagnostic circuitry configured to provide network condition information; and
a communications interface communicatively coupled to the signal interface and timing circuitry, the communications interface comprising:
a first line receiver circuitry communicatively coupled to a network connector and configured to receive a first voltage and a first current associated with the network communications protocol; and
a push-pull driver circuitry configured to produce a second voltage and a second current transmitted through the network connector, wherein the diagnostic circuitry is configured to use at least one of the first voltage, the first current, or a network state information to provide the network condition information.

2. The system of claim 1, wherein the network communications protocol comprises an Attached Resource Computer Network (ARCNET) version 878.1 or a higher version.

3. The system of claim 1, wherein the diagnostic circuitry is configured to use at least one of the second voltage or the second current to provide the network condition information.

4. The system of claim 1, wherein the network state information comprises a network state, a network state transition, or a combination thereof.

5. The system of claim 4, wherein the network transition comprises a transition due to timer lost token (TLT) timeout, a transition due to a frame not acceptable, a transition due to the frame being incorrect, a transition due to an invalid data packet (PAC) format, a transition due to no response to a free buffer enquiry (FBE), or a combination thereof.

6. The system of claim 1, comprising a comparator communicatively coupled to the diagnostic circuitry, wherein the first voltage is compared by the comparator to a voltage threshold and a comparison value is communicated to the diagnostic circuitry to provide the network condition information.

7. The system of claim 1, comprising a comparator communicatively coupled to the diagnostic circuitry, wherein the first current is compared by the comparator to a current threshold and a comparison value is communicated to the diagnostic circuitry to provide the network condition information.

8. The system of claim 7, comprising a threshold setting circuitry communicatively coupled to the comparator, wherein the voltage threshold is provided by the threshold setting circuitry.

9. The system of claim 1, comprising a Peripheral Component Interconnect (PCI) slave interface circuitry communicatively coupled to a P1 bus connector and to a P2 bus connector, wherein the P1 and the P2 bus connectors are configured to communicate with a bus, and wherein the PCI slave interface circuitry is configured to communicatively interface between the P1 and the P2 bus connectors, and the network protocol handler circuitry to transfer data between the bus and the network connector.

10. The system of claim 9, comprising a plurality of registers and a memory, and wherein the PCI slave interface circuitry is configured to use the plurality of registers and the memory to communicate with the network protocol handler circuitry.

11. The system of claim 1, comprising a second line receiver circuitry communicatively coupled to the network connector and configured to receive the first voltage and the first current associated with the network communications protocol, and wherein the first line receiver is configured for use in providing only network diagnostics and the second line receiver is configured for use in providing only network communications.

12. A method comprising:
deriving a network state and a network state transition by using a network protocol finite state machine (FSM);
deriving a network condition based on the network state, the network state transition, or a combination thereof;
providing feedback based on the network condition, wherein the finite state machine includes an Attached Resource Computer Network (ARCNET) version 878.1 or a higher version protocol.

13. The method of claim 12, wherein the deriving the network condition comprises counting a number of occurrences of the network state, the network state transition, or a combination thereof, during a specified time period.

14. The method of claim 13, wherein the time period comprises approximately between 1 millisecond and 10 seconds.

15. The method of claim 12, comprising measuring a voltage, and wherein deriving the network condition comprises comparing the voltage to a voltage threshold.

16. The method of claim 12, comprising measuring a current, and wherein deriving the network condition comprises comparing the current to a current threshold.

17. A system comprising:
a network card configured to communicate by using a network protocol, the network card comprising:
a network protocol handler circuitry configured to communicate by using the network protocol;
a signal interface and timing circuitry communicatively coupled to the network protocol handler circuitry;
a diagnostic circuitry configured to provide network condition information; and
a communications interface communicatively coupled to the signal interface and timing circuitry, the communications interface comprising:
a first line receiver circuitry communicatively coupled to a network connector and configured to receive a first voltage and a first current associated with the network protocol; and
a push-pull driver circuitry configured to produce a second voltage and a second current transmitted through the network connector, wherein the diagnostic circuitry is configured to use at least one of the first voltage, the first current, or a network state information to provide the network condition information.

18. The system of claim 17, wherein the first voltage comprises a sinusoidal voltage having a positive peak and a negative peak.

19. The system of claim 17, wherein the first current comprises a dipulse current having a first positive peak and a second positive peak.

20. The system of claim 17, wherein the network card is included in an industrial control system.
